(19) United States
(12) Patent Application Publication
(10) Pub. No.: US 2006/0050514 A1
(43) Pub. Date: Mar. 9, 2006

(54) Led lamp

(75) Inventor: Harald Opolka, Solingen (DE)

Correspondence Address: THE FIRM OF KARL F ROSS, 5676 RIVERDALE AVENUE, PO BOX 900, RIVERDALE (BRONX), NY, 10471-0900, US

(73) Assignee: ZWEIBRUDER OPTOELECTRONICS GMBH

(21) Appl. No.: 11/215,774

(22) Filed: Aug. 30, 2005

(30) Foreign Application Priority Data
Sep. 4, 2004 (DE) 202004013773.9

(51) Int. Cl. F21V 29/00

(52) U.S. Cl. 362/294

(57) ABSTRACT

A lamp has an at least partially transparent globe and a base carried on the globe, forming a passive heat-dissipating sink, and fittable in a socket. An LED is fitted to an inner surface of the base. Heat-generating driver circuitry connected to the LED is in heat-conducting contact with the base.

### FIELD OF THE INVENTION

The present invention relates to a lamp or bulb adapted to emit light and removably fittable with a standard socket. More particularly this invention concerns an LED lamp.

### BACKGROUND OF THE INVENTION

The main problem with the standard lamp having a resistive, e.g. tungsten, heating element is that such a lamp expends more energy as heat than as light. Fluorescent lamps run substantially cooler, but have a substantial lag time between when they are initially turned on and when they actually start emitting light, and also are often fairly bulky. Halogen lamps are highly efficient, but need to be handled very carefully and can in fact generate considerable heat when they are dimensioned big enough to generate a usable amount of light, even when powered with low, e.g. 12 V, voltage.

The most recent development involves the use of light-emitting diodes (LED's) that are quite efficient in that they are able to convert virtually all of their supply voltage into light, not into heat. In addition they are very small and have an extremely long service life, mainly due to the fact that they operate cool. The main problem with such LED lamps is that when used to replace a conventional incandescent bulb they must have special driving circuits that convert the incoming alternating-current line voltage to the direct-current low voltage needed by the lamp. Such a circuit is normally a small printed-circuit board that is permanently mounted right in the lamp and to which the LED is normally directly soldered. It typically incorporates a transformer to step down the incoming voltage and a rectifier and similar power-supply elements that produce the necessary steady low voltage.

The problem with this construction is that the driving circuit itself generates heat, particularly when the LED itself requires some meaningful amperage, albeit at low voltage. Since the LED itself is carried right on the circuit board, when the circuit elements heat up, the LED is heated. Unfortunately the efficiency of an LED falls off rapidly as it gets hot, so that the known LED lamps tend to dim somewhat after they have been in use for a while and their driving circuits have gotten warm.

### OBJECTS OF THE INVENTION

It is therefore an object of the present invention to provide an improved LED lamp.

Another object is the provision of such an improved LED lamp that overcomes the above-given disadvantages, in particular that produces a high light output even when its driving circuit is dissipating considerable heat.

### SUMMARY OF THE INVENTION

A lamp has according to the invention an at least partially transparent globe and a base carried on the globe, forming a massive heat-dissipating sink, and fittable in a socket. An LED is fitted to an inner surface of the base. Heat-generating driver circuitry connected to the LED is in heat-conducting contact with the base.

Thus the instant invention exploits the normally metallic base by designing it to dissipate the heat generated by the LED, or more by its driver circuitry. This makes it possible to use a high-power, e.g. 5 W, LED in a format that directly replaces a standard incandescent bulb, right down to the screw-type E14 or E17 base and glass globe.

The base according to the invention has an external formation adapted to mate with the socket. This formation can be a bayonet coupling or a screwthread.

The circuitry in accordance with the invention includes a transformer, and normally also a rectifier and various capacitors, chokes, and the like intended to convert the incoming line-voltage alternating current to the required low-voltage direct current.

The base according to the invention has an extension projecting into the globe and forming the surface carrying the LED. More specifically the base is formed with heat-dissipating ribs. It can also have at least one heat-dissipating bore.

In an embodiment of this invention the base comprises an externally and internally threaded sheet-metal shell adapted to fit a standard incandescent-bulb socket, a massive metallic element threaded snugly into the shell and in intimate heat-exchange contact therewith, and a tubular extension projecting inward from and formed unitarily with the element and having an inner end forming the surface carrying the circuitry and LED. This extension is provided with at least one radially projecting heat-dissipating disk.

### BRIEF DESCRIPTION OF THE DRAWING

The above and other objects, features, and advantages will become more readily apparent from the following description, it being understood that any feature described with reference to one embodiment of the invention can be used where possible with any other embodiment and that reference numerals or letters not specifically mentioned with reference to one figure but identical to those of another refer to structure that is functionally if not structurally identical. In the accompanying drawing:

FIG. 1 is a side view of a lamp according to the invention;

FIG. 2 is a section taken along line II-II of FIG. 1;

FIG. 3 is a top view of the base of the structure of FIG. 1, taken along line III-III of FIG. 11

FIGS. 4, 5, and 6 are sectional views like FIG. 2 showing other lamps in accordance with the invention; and

FIG. 7 is a large-scale exploded perspective view of parts of the lamp of FIG. 6.

### SPECIFIC DESCRIPTION

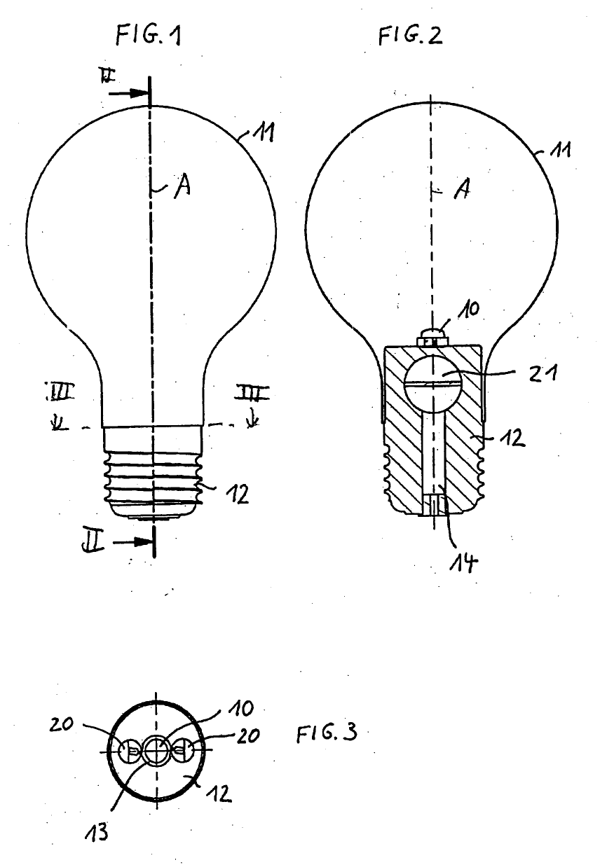

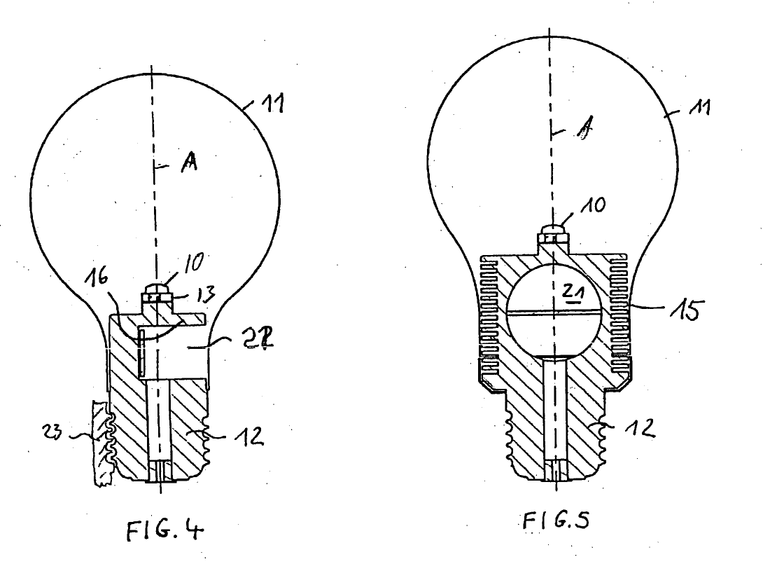

As seen in FIGS. 1 through 3, a lamp intended to replace a standard line-voltage incandescent lamp has a glass globe 11 centered on an axis A and fitted with a standard E14 or E17 metallic screw-type base 12. According to the invention the base 12 is formed as a fairly massive thermally conductive and normally metallic part that acts as an effective heat sink. At its innermost end it carries an LED 10 of at least 0.5 W nominal rating, here 5 W. The massive heat-sink base 12 has an inner end face to which is secured a printed-circuit board 13 to which the LED 10 is soldered and is in solid thermal contact with this board 13 so that it dissipates any heat generated by it.

Internally the heat-sink base 12 is formed with a crosswise throughgoing bore 21 and with a blind central longitudinal passage 14 and two flanking axially throughgoing passages 20. These passages 20 and 21 increase the surface area from which heat can be radiated.

In the arrangement of FIG. 4 the base 12 is formed with, a deep radially open slot 22 defining a thin lip 16 on which the board 13 and LED 10 are mounted. Here, once again, the base 12 is a relatively massive metal part intended to transmit any heat generated by the board 13 to the socket holding the LED lamp. FIG. 4 also shows at 23 a portion of a socket the lamp.

In FIG. 5 the base 12 is formed inside the globe 11 with heat-dissipating annular metal strips or fins 15.

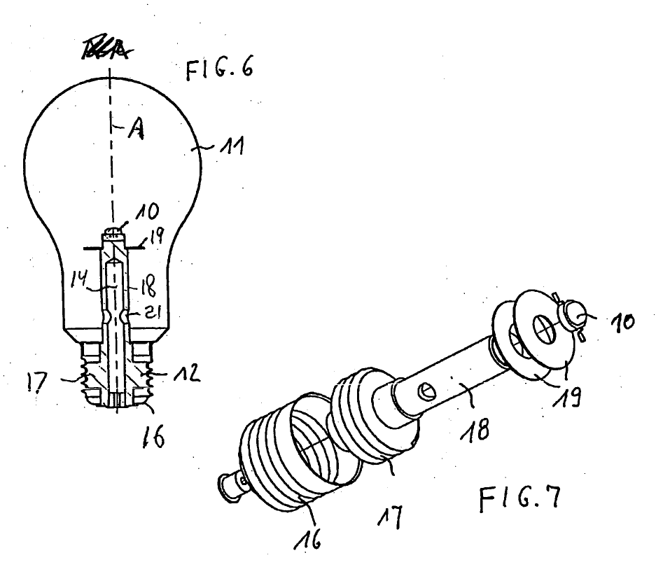

FIGS. 6 and 7 show a system where the massive base 12 has an externally threaded portion 17 fitted into the standard sheet-metal lamp base. Unitary with this base 12 is an axially inwardly projecting tubular extension 113 to which are secured heat-dissipating washers or plates 19, with the LED mounted at the inner end of the extension tube 18. This arrangement makes replacement of the LED 10 fairly easy.

Of course, instead of a screwthread, the heat-sink base 12 could be formed with pins of a bayonet coupling, or otherwise comply with standard lamp-base forms. Similarly the LED 10 can be mounted via heat-dissipating metal strips or the like to the heat-sink base 12. The circuit board 13 can carry a transformer and even a rectifier so that an LED lamp according to the invention using a low-voltage direct-current LED can be screwed into a higher voltage—110 or 220 volt alternating-current—socket to directly replace a conventional incandescent or fluorescent bulb.

I claim:

1. A lamp comprising:
an at least partially transparent globe;
a base carried on the globe, forming a massive heat-dissipating sink, and fittable in a socket;
an LED fitted to an inner surface of the base; and
heat-generating driver circuitry connected to the LED and in heat-conducting contact with the base.

2. The lamp defined in claim 1 wherein the base has an external formation adapted to mate with the socket.

3. The lamp defined in claim 2 wherein the formation is a screwthread.

4. The lamp defined in claim 1 wherein the circuitry includes a transformer.

5. The lamp defined in claim 1 wherein the base has an extension projecting into the globe and forming the surface carrying the LED.

6. The lamp defined in claim 1 wherein the base is formed with heat-dissipating ribs.

7. The lamp defined in claim 1 wherein the base is formed with at least one heat-dissipating bore.

8. The lamp defined in claim 1 wherein the base comprises:
an externally and internally threaded sheet-metal shell adapted to fit a standard incandescent-bulb socket;
a massive metallic element threaded snugly into the shell and in intimate heat-exchange contact therewith; and
a tubular extension projecting inward from and formed unitarily with the element and having an inner end forming the surface carrying the circuitry and LED.

9. The lamp defined in claim 8 wherein the extension is provided with at least one radially projecting heat-dissipating disk.
